(19) United States
(12) Patent Application Publication
(10) Pub. No.: US 2022/0180353 A1
(43) Pub. Date: Jun. 9, 2022

(54) LOCATION-BASED CONTROL OF A FUNCTION

(71) Applicant: Capital One Services, LLC, McLean, VA (US)

(72) Inventors: Lee ADCOCK, Midlothian, VA (US); Vamsi KAVURI, Richmond, VA (US); Jignesh RANGWALA, Glen Allen, VA (US); Mehulkumar Jayantilal GARNARA, Glen Allen, VA (US); Muthukumaran VEMBULI, Glen Allen, VA (US); Srikanth Reddy SHESHAIAHGARI, Henrico, VA (US); Santhi SRIDHARAN, Glen Allen, VA (US)

(21) Appl. No.: 17/247,233

(22) Filed: Dec. 4, 2020

(51) Int. Cl. G06Q 20/34; G06Q 20/40; G06Q 20/32; H04W 4/029

(52) U.S. Cl. CPC G06Q 20/341; H04W 4/029; G06Q 20/3224; G06Q 20/4015

(57) ABSTRACT

In some implementations, a card may receive, from a user device, a location-based configuration message associated with authorizing use of the function. The card may identify, within the location-based configuration message, a set of identifiers associated with one or more base stations of a wireless wide area network. The card may store the set of identifiers in a local data structure of the card. The card may receive, from a base station and via the wireless communication component, a broadcast message that includes a broadcast identifier associated with the base station. The card may determine whether the broadcast identifier is included within the set of identifiers stored in the local data structure. The card may perform an action associated with activating or deactivating the function based on whether the broadcast identifier is included within the set of identifiers.

### BACKGROUND

A transaction card may include various hardware components to assist with facilitating a secure transaction with a transaction terminal. For example, a transaction card may include an integrated circuit (IC) chip to improve security with respect to use of the transaction card. The IC chip may include a secure element to validate and/or authenticate a transaction utilizing the transaction card. Some transaction cards include a contactless component, such as a near field communication (NFC) antenna or a Bluetooth Low Energy (BLE) antenna, to allow contactless communication between the transaction card and a transaction terminal.

### SUMMARY

In some implementations, a card configured for local location-based control of a function includes a wireless communication component, one or more memories, and one or more processors, communicatively coupled to the one or more memories, configured to: receive, from a user device, a location-based configuration message associated with authorizing use of the function; identify, within the location-based configuration message, a set of identifiers associated with one or more base stations of a wireless wide area network, wherein the one or more base stations are positioned in an authorized area in which the function is to be activated; store the set of identifiers in a local data structure of the card; receive, from a base station and via the wireless communication component, a broadcast message that includes a broadcast identifier associated with the base station; determine whether the broadcast identifier is included within the set of identifiers stored in the local data structure; and perform an action associated with activating or deactivating the function based on whether the broadcast identifier is included within the set of identifiers.

In some implementations, a method of locally controlling a function of a card includes receiving, by the card, a set of identifiers that identify a set of wireless access points; monitoring, via a wireless communication component of the card, for broadcast messages to determine whether the card is within an area associated with one or more wireless access points of the set of wireless access points; determining, by the card, that a received broadcast message includes an identifier of the set of identifiers; and activating, by the card and based on the received broadcast message including the identifier, the function of the card.

In some implementations, a non-transitory computer-readable medium storing a set of instructions includes one or more instructions that, when executed by one or more processors of a card, cause the card to: receive, from a wireless access point and via a wireless communication component of the card, a message that includes an identifier of the wireless access point; determine, based on the identifier, that the card is within a geographic area in which use of a function of the card is authorized; and activate the function based on determining that the card is within the geographic area.

### BRIEF DESCRIPTION OF THE DRAWINGS

FIGS. 1A-1C are diagrams of an example implementation relating to location-based control of a function.

FIG. 2 is a diagram of an example environment in which systems and/or methods described herein may be implemented.

FIG. 3 is a diagram of example components of one or more devices of FIG. 2.

FIG. 4 is a flowchart of an example process relating to location-based control of a function.

### DETAILED DESCRIPTION

The following detailed description of example implementations refers to the accompanying drawings. The same reference numbers in different drawings may identify the same or similar elements.

A transaction card may be used to facilitate transaction processing at a transaction terminal, such as a point of sale (PoS) terminal, an automated teller machine (ATM) terminal, an access terminal (e.g., as a locking mechanism for a gate, a door, or a room), or a reward redemption terminal, among other examples. In some instances, location-based authorization to use a transaction card to facilitate or perform a transaction (e.g., a financial transaction, a credentials-based transaction to obtain access to a secure area, or the like) may be restricted to certain areas (e.g., geographical areas or jurisdictions). Such location-based authorization may be performed and/or implemented for transactions of a transaction card to detect or prevent potential fraudulent (or unauthorized) use of the transaction card initiated outside of those certain areas.

Typically, location-based authorization involves a transaction backend receiving a request from a transaction terminal to authorize an initiated transaction involving a transaction card. The transaction backend determines a location associated with the transaction based on the request from the transaction terminal (e.g., using a source address associated with the transaction terminal or a network device used to communicate the request). The transaction backend then determines whether to authorize or deny the transaction based on the determined location, and transmits a response to the transaction terminal that indicates whether the transaction is authorized or denied. Accordingly, such techniques involving location-based authorization require a transaction to be initiated with a transaction terminal and result in consumption of computing resources (e.g., processor resources and/more memory resources) of the transaction terminal and/or transaction backend to authorize or deny the transaction. Furthermore, such techniques require communication resources and/or network resources to be consumed to transmit a request for authorization and/or receive a response indicating authorization or denial of the transaction.

Some implementations described herein provide a transaction card that locally performs location-based control of a function of the transaction card. For example, as described herein, a transaction card may be configured to self-monitor and/or self-detect a location of the transaction card based on detected broadcast message(s) from one or more access points associated with a wireless communication network. The transaction card may determine whether the transaction card is within an authorized area associated with a function or component used to engage in a transaction with a transaction terminal based on a set of identifiers of a set of access points associated with the authorized area. For example, the set of identifiers may be stored in a local data structure of the transaction card and compared to received identifiers in a broadcast message. When the transaction card makes a determination that a received identifier (e.g., received in a broadcast message) matches a stored identifier (e.g., the received identifier is included in the set of identifiers), the transaction card may locally perform a location-based authorization (e.g., that is specific to the transaction card or a user of the transaction card) and may activate a function of the transaction card to permit the transaction card to initiate or engage in a transaction with a transaction terminal.

However, when the transaction card determines that the transaction card is outside of an authorized area (e.g., when a received identifier does not match a stored identifier), the transaction card may deactivate a function or component associated with initiating or engaging in the transaction with a transaction terminal. In this way, a transaction card that is configured as described herein may prevent or reduce consumption of computing resources and/or network resources as compared to other types of location-based authorization of a transaction (e.g., remote location-based authorization). For example, the computing resources that would otherwise have been consumed by the transaction terminal and/or a transaction backend to perform location-based authorization of the transaction are conserved by the transaction card preventing the initiation of the transaction or engagement in the transaction (e.g., by deactivating the function when outside of the authorized area, by preventing transmission of a transaction token of the transaction card, or the like). Furthermore, local location-based authorization may be less susceptible to hacking than remote location-based authorization, in which messages may be intercepted and modified via a network. In some cases, both local location-based authorization and remote location-based authorization may be used, thereby further increasing security.

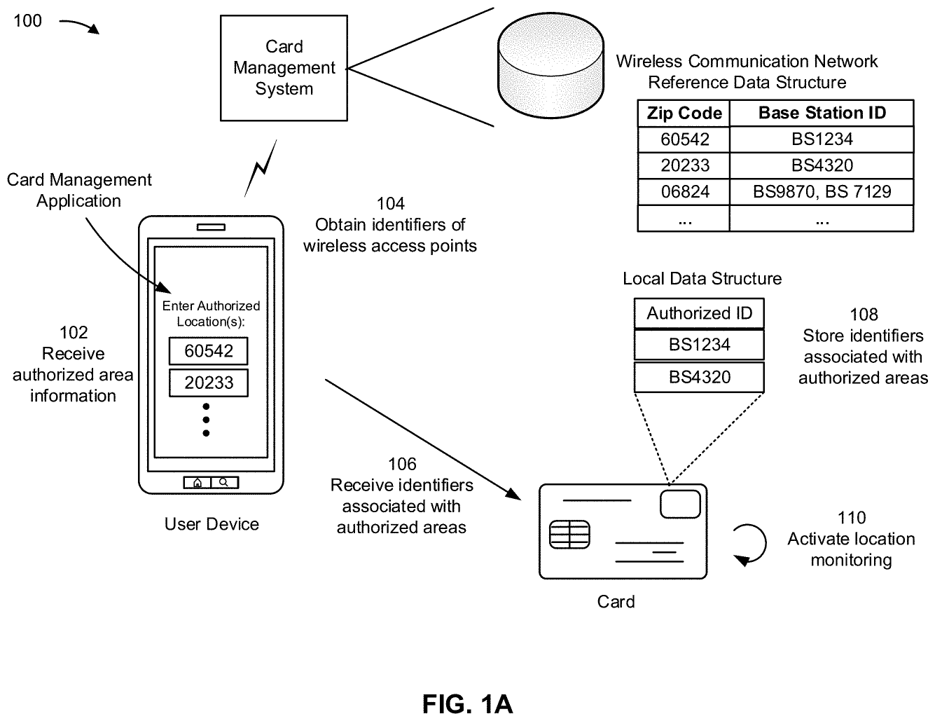

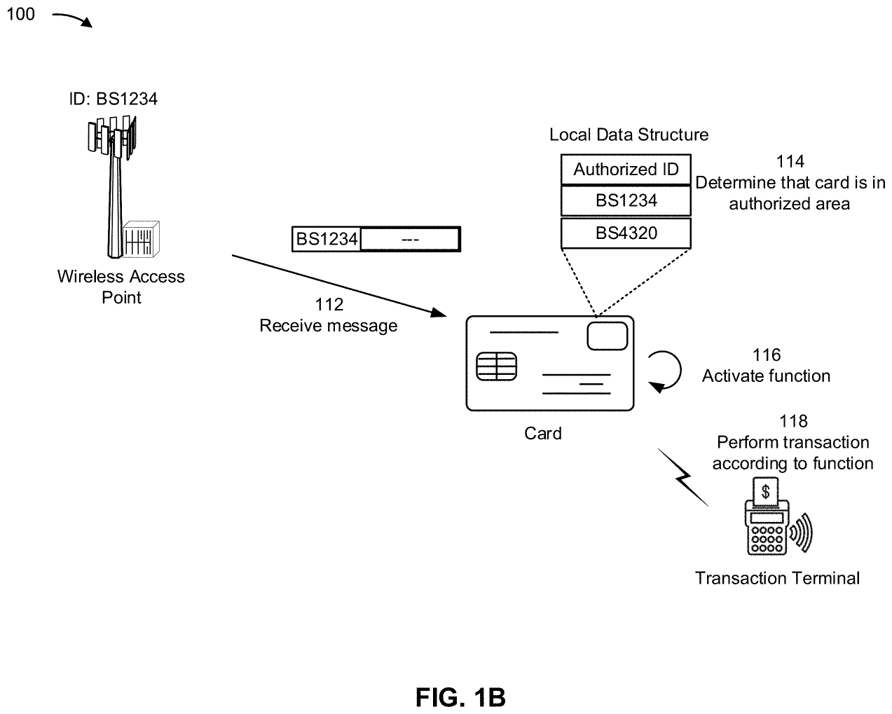

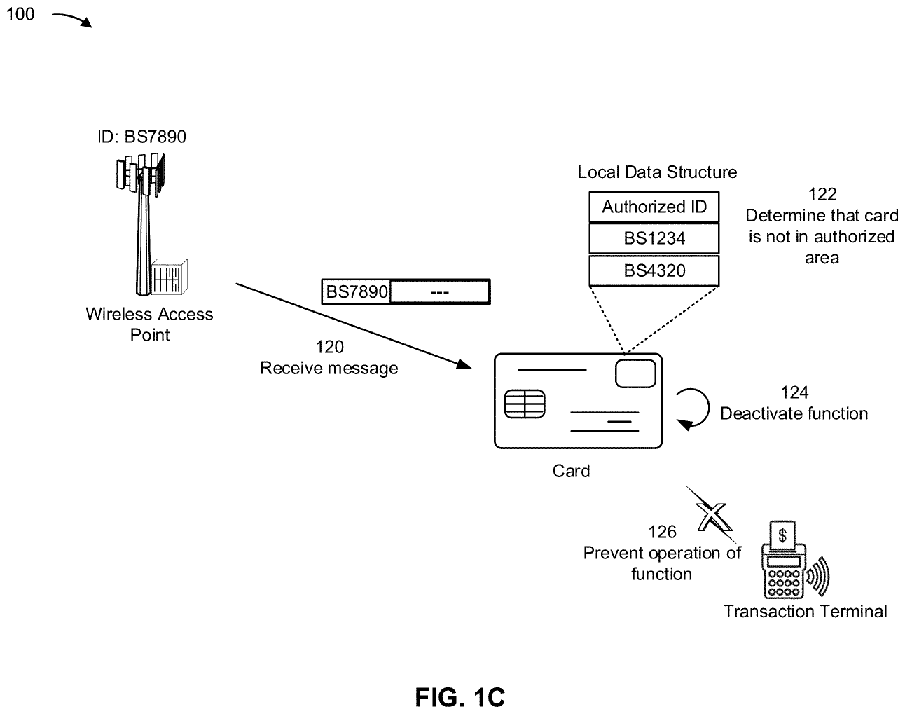

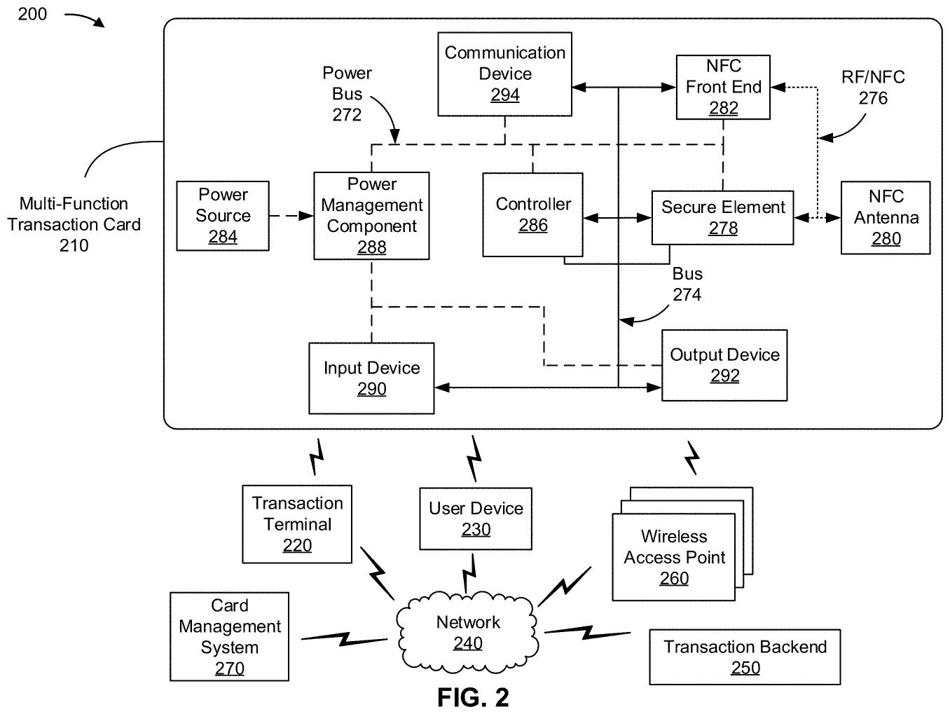

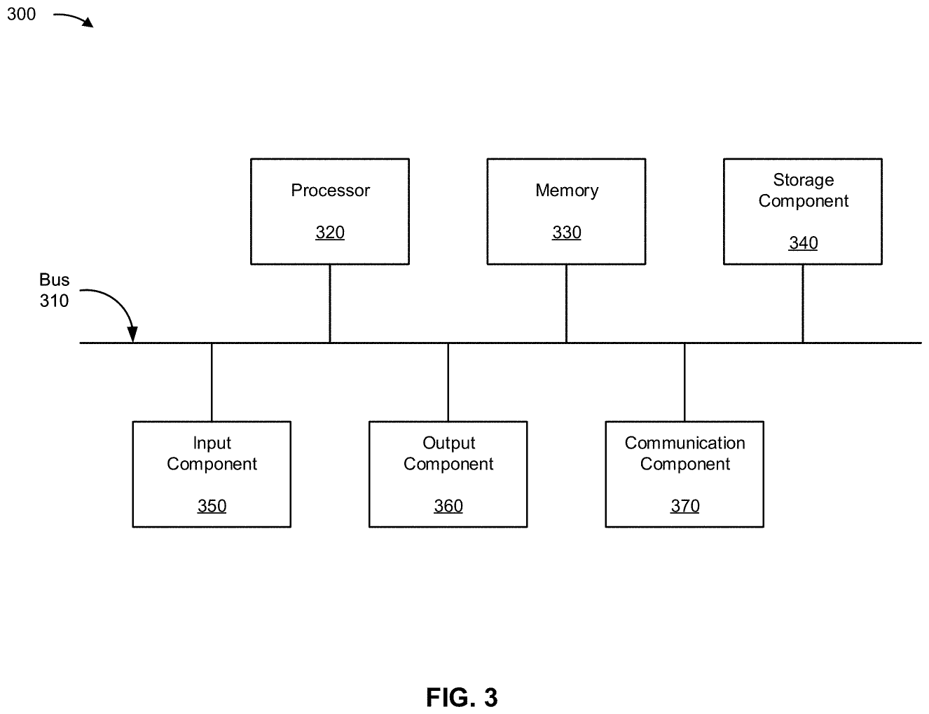

FIGS. 1A-1C are diagrams of an example implementation 100 associated with location-based control of a function. As shown in FIGS. 1A-1C, example implementation 100 includes a card (e.g., a transaction card), a user device, a card management system, a transaction terminal, and a wireless access point. These devices are described in more detail below in connection with FIG. 2 and FIG. 3.

The card management system may manage a transaction account associated with the transaction card. The transaction account may include a financial account (e.g., a credit account, a debit account, or the like) for financial transactions (e.g., payments, deposits to the financial account, withdrawals from the transaction account, or the like), a security access account for access transactions (e.g., providing security credentials to access a secure area), and/or a loyalty account for loyalty rewards based on transactions (e.g., redemption of loyalty points, purchase of loyalty points, or the like), among other examples. The transaction account may be associated with (e.g., registered to or available to) a user to permit the user to engage in transactions via the transaction account (e.g., using funds associated with the transaction account). The transaction account may be managed and/or maintained by the card management system for the user (e.g., using a transaction log to permit the user to view and/or access transaction activity of the transaction account). In some implementations, the card management system may manage hundreds, thousands, or more transaction accounts for hundreds, thousands, millions or more cards, each of which may be used in hundreds, thousands, millions, or more transactions.

The card management system may be associated with a card management application that is installed and/or executing on the user device, in accordance with one or more implementations described herein. For example, the card management system may serve as a backend system of the card management application. The card management application may be utilized to configure one or more settings of the card (e.g., to configure authorized areas of use of one or more functions of the card) and/or to manage a transaction account of the card (e.g., to review and/or manage transactions associated with the card). For example, the user device may be associated with a user (e.g., an authorized user) that has a transaction account that is managed by the card management system.

In some implementations, the card management application may utilize one or more authentication techniques to authenticate a user of the user device (e.g., to verify that the user is associated with the transaction account of the card). For example, the card management application may authenticate a user of the user device based on a set of user credentials of the user (e.g., a username/password combination and/or a biometric of the user, among other examples), multi-factor authentication, or the like. Additionally, or alternatively, the card may include a secure element that is configured to verify that the user device is authorized to communicate with the card and/or configure settings of the card based on the user of the user device being authenticated via the card management application and/or the card management system. For example, the secure element may maintain a security token that is generated and/or provided based on authentication of the user. The security token may authorize, based on receiving the set of credentials from the user device, a controller of the card to be updated according to instructions from the card management application and/or the user device.

As shown in FIG. 1A, and by reference number 102, the user device may receive authorized area information. The authorized area information may identify one or more areas (e.g., one or more locations and/or geographic regions) within which the card and/or a function of the card is authorized for use (e.g., referred to herein as an “authorized area”). In some implementations, a user may interact with the user device to provide user input that includes the authorized area information. For example, the user input and/or authorized area information may include and/or be identified by one or more of a zip code, a street address, a name (e.g., a name of a region, a jurisdiction, a merchant, or the like), geographical coordinates, a radius from a location (e.g., from a zip code and/or an address), and/or any other type of information that identifies a location or a geographic region.

While some implementations are described herein in connection with the card controlling a function of the card based on determining that the card is within an authorized area (e.g., enabling the function when the card is within the area identified in the authorized area information), other implementations may similarly involve the card controlling the one or more functions based on determining that the card is within an unauthorized area for using the one or more functions (e.g., areas within which the function is to be disabled). In this case, the authorized area information may include information that identifies one or more unauthorized areas.

As further shown in FIG. 1A, and by reference number 104, the user device may obtain identifiers of wireless access points. For example, the user device may obtain the identifiers from the card management system. As shown, the card management system may include and/or be associated with a wireless communication network reference data structure. This data structure may store mappings of identifiers of wireless access points to one or more of geographical areas and/or geographical locations. For example, the mappings may be associated with a geographical-based system (e.g. a military grid reference system (MGRS)) that indicates, in association with corresponding geographical areas, base station identifiers of wireless base stations (e.g., of a wireless wide area network (WWAN), such as a cellular communication network), service set identifiers (SSIDs) for wireless routers (e.g., of a wireless local area network (WLAN)), or other identifiers of other wireless access points that are located in the corresponding geographical areas. The mappings may have been generated and/or stored during an identifier collection and/or detection operation. For example, one or more other user devices (e.g., that were previously within the geographical areas) may have previously detected or received the identifiers within broadcast messages (e.g., advertisements) of the wireless access points in the geographical areas.

Accordingly, based on receiving the authorized area information, the user device may send a request (e.g., that includes the authorized area information), to the card management system, for identifiers associated with wireless access points in the areas identified in the authorized area information. The card management system may look up the areas in the wireless communication network reference data structure using the authorized area information (e.g., one or more zip codes, as shown), identify the identifiers that are mapped to the areas, and provide the identifiers in a response to the user device. In some implementations, a single area identifier (e.g., a zip code), that identifies an authorized area, may be mapped to a single wireless access point identifier that identifies a wireless access point that serves the authorized area. Additionally, or alternatively, a single area identifier may be mapped to multiple wireless access point identifiers, such as when multiple wireless access points serve an authorized area indicated by the single area identifier.

In the example of FIG. 1A, the user interacts with the user device to input zip codes of 60542 and 20233. The user device transmits these zip codes to the card management system, which looks up base station identifiers, corresponding to these zip codes, in the wireless communication network reference data structure. As shown, the zip code of 60542 is mapped to a base station identifier of BS1234, and the zip code of 20233 is mapped to a base station identifier of BS4320. The card management system transmits these base station identifiers to the user device (e.g., via a first network). The user device transmits the base station identifiers to the card (e.g., via a second network, such as a near-field communication (NFC) network or a Bluetooth network), as described below. Alternatively, the card management system may transmit the base station identifiers directly to the card if the card includes appropriate communication components (e.g., for Wi-Fi communication or cellular communication).

As further shown in FIG. 1A, and by reference number 106, the card may receive identifiers associated with the authorized areas. As described elsewhere herein, the identifiers may be base station identifiers, SSIDs, or other identifiers of wireless access points in the authorized areas. In some implementations, the card may receive the identifiers within a location-based configuration message associated with authorizing a function within authorized areas identified in the authorized area information. For example, the location-based configuration message may identify one or more functions that are to be controlled based on the card being within an authorized area that includes one or more wireless access points identified by the identifiers. Alternatively, the card may store information that identifies the one or more functions, and the location-based configuration message may include the wireless access point identifiers, and not information that identifies the function(s) to be controlled based on a location of the card.

The card may receive the location-based configuration message from the user device via a wireless communication link (e.g., via a Bluetooth link, a Bluetooth Low Energy (BLE) link, an NFC link, or the like). Prior to receiving the location-based configuration message and/or the identifiers, the wireless communication link may have been previously established with the user device according to one or more of the authentication processes described elsewhere herein. The card may receive the identifiers from the user device based on the user device obtaining the identifiers from the card management system. Additionally, or alternatively, the card may obtain the identifiers directly from the card management system (e.g., via a wireless communication network and/or based on receiving the location-based configuration message).

In some implementations, the card verifies, based on one or more authentication techniques, that the user device is authorized to communicate with the card, authorized to configure a function of the card, authorized to configure settings of the card, or the like. For example, the card may verify that the identifiers are being received from an authorized user of the user device based on an authentication token from the user device and/or a security token of the transaction card that permits the user device to communicate with and/or configure one or more settings of the card.

According to some implementations, the card may receive the identifiers during an initial setup operation of the card (e.g., when the card is issued to the user or when the card is manufactured). For example, the card may receive the identifiers from a system or machine that configures the card for a user or that manufactures or prints the card. In some implementations, the card may receive the identifiers as a preconfigured set of identifiers that are fixed and/or unchangeable. In such a case, the authorized area for use of a function of the card may be preconfigured and/or fixed over the useful life of the card.

As further shown in FIG. 1A, and by reference number 108, the card stores the identifiers (shown as “BS1234” and “BS4320”) within a local data structure of the transaction card. For example, the card may process the location-based configuration message to identify the identifiers within the location-based configuration message and/or extract the identifiers from the location-based configuration message. The local data structure may include a table, a list, an index, a graph, a database, or any other suitable data structure that is configured to store the identifiers for location-based control of a function of a card, as described herein. In some implementations, the local data structure may be stored in a secure element or another memory of the card.

The local data structure may be rewriteable to permit storage of reconfigurable sets of identifiers. For example, in example 100, the local data structure may include a previously received (or default) set of identifiers associated with previously indicated or default authorized areas. The previously received set of identifiers may be adjustable within the local data structure (e.g., based on being erasable, overwritable, editable, or the like). In some implementations, the received set of identifiers in example 100 may be stored in the local data structure by being added to the previously received set of identifiers (e.g., to add one or more additional authorized areas for location-based control of the card). Additionally, or alternatively, the received set of identifiers may be stored in the local data structure by overwriting the previously received set of identifiers (e.g., to update or adjust the authorized areas for location-based control of the card).

In some implementations, the local data structure may be configured as a read-only data structure. In such a case, the received and/or stored identifiers may be read-only identifiers that are associated with preconfigured identifiers and/or default identifiers that are fixed and/or unchangeable within the local data structure.

As further shown in FIG. 1A, and by reference number 110, the card activates location monitoring. For example, the card may activate location monitoring by configuring a wireless communication component of the card to receive broadcast messages from wireless access points. More specifically, the card may configure the wireless communication component to monitor a set of radio frequencies that are used by wireless access points to transmit broadcast messages. Such broadcast messages transmitted by a wireless access point may include any suitable message used by the wireless access point to indicate a presence of the wireless access point and/or to establish communication links with client devices to permit the client devices to access one or more networks of the wireless access point.

For example, a broadcast message that includes a base station identifier for a cellular network (or WWAN) may include a master information block (MIB), a system information block (SIB), a message on a physical broadcast channel (PBCH), a synchronization signal (e.g., a primary synchronization signal (PSS) or a secondary synchronization signal (SSS)), a cell-specific reference signal (CRS), and/or a synchronization signal block (SSB). As another example, a broadcast message that includes an SSID for a Wi-Fi access point may include a beacon frame.

The card may activate the location monitoring based on receiving the identifiers from the user device and/or storing the identifiers in the local data structure. Additionally, or alternatively, the card may activate the location monitoring based on receiving instructions from the user device (e.g., based on a user input to the card management application) and/or based on receiving instructions from the card management system.

In some implementations, the card may configure location monitoring to be activated according to one or more settings. For example, the card may configure the wireless communication component to monitor for broadcast messages according to a particular schedule. As a more specific example, the card may configure the wireless communication component to perform location monitoring during times that the card is more likely to be used in a transaction (e.g., during a day time, between 7 am and 11 pm, or the like) and/or may configure the wireless communication component to be on standby (or deactivate location monitoring) when the card is less likely to be used in a transaction (e.g., at night, between 11 pm and 7 am, or the like). Additionally, or alternatively, the card may configure a periodicity of monitoring a location of the card based on a determined location of the card. For example, when the card detects an SSID of a wireless access point (e.g., a wireless router) associated with a home location of the user, the card may reduce a frequency of monitoring the location of the card (e.g., because the user is unlikely to use the card to engage in a transaction with a transaction terminal while at home).

In some implementations, the card may configure location monitoring to be activated according to detecting one or more events. For example, the card may activate location monitoring based on detecting that the card is being used to initiate a transaction. More specifically, based on detecting that a chip of the card is interacting with a chip reader of a transaction terminal or that a magnetic stripe component of the card is being swiped through a card reader of a transaction terminal, the card may activate the location monitoring to determine whether the card is within an authorized area and control a function of the transaction card to facilitate the transaction (e.g., providing account information associated with the card to the transaction terminal, withholding account information from the transaction terminal, or the like).

In this way, the card may conserve power resources (e.g., battery power) of the card by enabling and/or disabling location-based monitoring based on certain factors, rather than continuously having location-based monitoring fixed in an always-on mode.

As shown in FIG. 1B, and by reference number 112, the card receives a message from a first wireless access point. The message includes an identifier “BS1234.” In some implementations, the identifier may be included within a header of the message or within a body of the message. The identifier may be a broadcast identifier of the first wireless access point (e.g., an identifier included in advertisements of the first wireless access point that are transmitted to establish communication links with one or more devices). As shown, the first wireless access point is identified by the “BS1234” and the message may be a broadcast message (e.g., an advertisement) of the first wireless access point. The card may receive the message from the first wireless access point based on being within communication range of the first wireless access point (e.g., after being moved by a user into the communication range of the first wireless access point). Accordingly, the card may receive and/or detect the broadcast message from the first wireless access point without establishing a communication link with the first wireless access point according to a wireless communication protocol of the first wireless access point.

As further shown in FIG. 1B, and by reference number 114, the card determines that the card is in an authorized area. For example, the card may determine whether the card is in the authorized area based on comparing the received identifier to the identifiers stored in the local data structure. The card may determine that the card is in the authorized area (or at least one of the authorized areas) based on identifying that the received identifier matches one of the identifiers stored in the local data structure of the transaction card. Accordingly, without establishing a communication link with the first wireless access point, the user device, the transaction terminal, or any other device, the card may determine that the card is within an authorized area. In this way, resources (e.g., computing resources, power resources, and/or network resources) associated with the card and/or a network may be conserved because the card and/or the network does not have to consume those resources to determine that the card is in the authorized area.

In some implementations, the card determines that the card is in an authorized area based on receiving a combination of identifiers within a threshold time period (e.g., 100 milliseconds, 500 milliseconds, one second, or the like). For example, if the first wireless access point is a base station of a cell of a cellular communication network, an authorized area may be a subsection of the cell within which a first identifier (e.g., “BS1234”) can be received from the base station in FIG. 1B and within which a second identifier (e.g., “BS4320”) can be received from another base station. Accordingly, if the card receives multiple different identifiers associated with an authorized area within the threshold time period, the card may determine that the card is within the authorized area. In this way, using multiple identifiers to define an authorized area, a size of the authorized area can be relatively smaller than using a single identifier to define an authorized area, which allows for more granular location monitoring of the card.

In some implementations, the card may determine that the card is in an authorized area based on a signal strength associated with receiving the message. For example, one or more of the identifiers of an authorized area may be associated with one or more signal strength ranges or signal strength thresholds associated with receiving the corresponding identifiers in broadcast messages. Referring to the example of the first wireless access point being a base station of a cellular communication network, the authorized area may be a subsection of the cell within which the card (or other devices) may receive broadcast messages from the base station with a signal strength within the designated range. More specifically, an authorized area associated with an identifier may be defined by receiving the identifier in a broadcast message with a signal strength that is greater than a minimum signal strength. In such a case, the authorized area may be relatively smaller than an area within which the card may receive the identifier in a broadcast range with any signal strength. Furthermore, an authorized area may be defined by one or more triangulation parameters (e.g., a particular quantity of detected identifiers, a particular set of signal strengths associated with receiving broadcast messages that include the identifiers, or the like) and/or the card may be configured to determine whether the card is within the authorized area according to the one or more triangulation parameters.

As further shown in FIG. 1B, and by reference number 116, the card activates a function based on receiving the identifiers. The card may activate the function based on determining that the card is within the authorized area. In some implementations, the function may be identified within the local data structure as being authorized for use when the identifier “BS1234” is received by the transaction card. Accordingly, the function may be activated based on the card receiving a message that includes the identifier “BS1234.” Additionally, or alternatively, the function may be activated based on the card receiving an input associated the function. For example, when the function involves facilitating a transaction, and when the card detects that a transaction has been initiated via the card (e.g., via a chip of the card, a magnetic stripe component of the card, or an NFC component of the card), the card may activate the function based on detecting that the transaction was initiated and based on detecting that the card is in the authorized area.

The function may include any suitable function of the card that is to be controlled according to a location of the card. For example, the function may facilitate a transaction and/or enable processing of a transaction of the card (e.g., by providing or receiving funds of a financial transaction, by obtaining access to a secure location, or the like). Additionally, or alternatively, the function may involve setting a configuration of the card and/or setting a configuration of another function of the transaction card. Accordingly, the function may involve enabling one or more operations of the function and/or configuring settings of the one or more operations of the function. The card may activate the function by activating one or more components used to perform the function, by supplying power to the one or more components, by establishing connections to the one or more components, or the like. In some implementations, the card may activate at least one of a chip of the card, a magnetic stripe component of the card, an NFC component of the card, or another component of the card (e.g., one or more components described elsewhere herein, such as in connection with FIG. 2 and/or FIG. 3). Additionally, or alternatively, the card may activate a controller to permit the controller to perform one or more operations of a function. Accordingly, when the function involves facilitating a transaction, the card may configure settings of one or more components and/or operations of the controller to permit the card to transmit account information to permit the transaction to be initiated, processed, and/or executed.

As further shown in FIG. 1B, and by reference number 118, the card performs a transaction according to the function. For example, the card may perform one or more operations in association with facilitating a transaction involving the transaction terminal. More specifically, based on the function being activated, the card may obtain information from and/or provide account information to the transaction terminal to cause the transaction terminal to process the transaction (e.g., by requesting authorization from a transaction backend) according to the account information.

In some implementations, the card may provide the identifier (e.g., the identifier received in the broadcast message, or a received identifier that matches a stored identifier) to the transaction terminal to cause the transaction terminal to provide the identifier, with an authorization request, to a transaction backend. In this way, the transaction backend may determine the location of the transaction and/or verify that the transaction is occurring within an authorized area of the card. Accordingly, the transaction backend may learn and/or identify a location of the transaction terminal (e.g., for fraud detection monitoring involving the transaction terminal). In some implementations, based on the location of the transaction terminal, the transaction backend may further verify that the transaction card and the transaction terminal are within a threshold proximity that indicates that the transaction is authorized according to the location of the card.

As shown in FIG. 1C, and by reference number 120, the card receives a message from a second wireless access point, in a similar manner as described above in connection with the first wireless access point. The message includes the identifier “BS7890,” which identifies the second wireless access point.

In some implementations, the first wireless access point and the second wireless access point may be associated with a same wireless communication network (e.g., a wireless communication network that is operated by a single mobile network operator and/or service provider). Alternatively, the first wireless access point and the second wireless access point may be associated with different wireless communication networks (e.g., the first wireless access point is operated by a mobile network operator and/or service provider that is different from the second wireless access point). In some implementations, the first wireless access point and the second wireless access point may be associated with a same type of wireless communication network (e.g., both the first wireless access point and the second wireless access point may be base stations of a WWAN, both the first wireless access point and the second wireless access point may be wireless routers of a WLAN, or the like). Alternatively, the first wireless access point and the second wireless access point may be associated with different types of wireless communication networks. For example, the first wireless access point may be a base station of a cellular communication network and the second wireless access point may be a wireless router of a WLAN.

As further shown in FIG. 1C, and by reference number 122, the card determines that the card is not in an authorized area. Similar to receiving the message from the first wireless access point, the card may determine whether the card is in an authorized area (or in an unauthorized area) based on comparing the identifier of the first wireless access point to the identifiers stored in the local data structure. The card may determine that the card is not in an authorized area (and/or is within an unauthorized area) based on determining that the received identifier does not match any of the identifiers stored in the local data structure of the transaction card. Accordingly, without establishing a communication link with the first wireless access point, the user device, the transaction terminal, or any other device, the card may determine that the card is not within an authorized area. Accordingly, without having to receive a communication to determine whether the card is within an authorized area (or in an unauthorized area), the card, relative to previous location-based monitoring techniques, may conserve computing resources, network, resources, and/or processor resources associated with transmitting and/or receiving the communication.

In some implementations, identifiers associated with wireless access points in specific unauthorized areas may be included within the local data structure (e.g., a geographic area known to be associated with fraud or theft). For example, the local data structure may include an entry that indicates whether the second wireless access point is or is not associated with an unauthorized area. In such a case, the card may determine that the card is within an unauthorized area based on the identifier matching an identifier in the local data structure that is associated with an unauthorized area.

As further shown in FIG. 1C, and by reference number 124, the card deactivates the function. The card may deactivate the function based on determining that the card is not within the authorized area and/or based on determine that the card is within an unauthorized area. Deactivating the function may involve disabling one or more operations of the function and/or configuring settings of the one or more operations to prevent the one or more operations of the function.

The card may deactivate the function by deactivating one or more components used to perform the function, by removing or reducing power supplied to the one or more components, by disconnecting connections to the one or more components (e.g., using a switch), or the like. In some implementations, the card may deactivate at least one of a chip of the card, a magnetic stripe component of the card, an NFC component of the card, and/or another component of the card (e.g., one or more components described elsewhere herein, such as in connection with FIG. 2 and/or FIG. 3). Additionally, or alternatively, the card may deactivate a controller to prevent one or more operations of a function. Accordingly, when the function involves facilitating a transaction, the card may configure settings of one or more components and/or operations of the controller to cause the card to refrain from transmitting account information (to the transaction terminal) to prevent the transaction from being initiated, processed, and/or executed.

As further shown in FIG. 1C, and by reference number 126, the card prevents an operation of a function from being performed. For example, based on the identifier indicating that the card is not in an authorized area, the card may prevent an operation associated with the card transmitting or providing account information to the transaction terminal. The card may reactively prevent the operation based on a component of the card initiating a transaction with the transaction terminal. Additionally, or alternatively, the card may proactively prevent the transaction card from performing the operation by deactivating one or more components of the card that permit the card to attempt to initiate a transaction with the transaction terminal.

Accordingly, as described herein, the transaction card may be configured to self-monitor and/or self-detect a location of the transaction card (e.g., based on detected identifiers of wireless access points of a wireless communication network) and locally control a function of the transaction card based on the location (e.g., to authorize or prevent a transaction from occurring, to authorize or prevent an update to a setting of the transaction card, or the like). In this way, the transaction card may conserve, relative to other techniques, computing resources and/or network resources associated with performing location-based authorization of transactions of the transaction card and/or location-based control of a function of the transaction card. Furthermore, the transaction card may provide improved security with respect to other techniques (e.g., by preventing opportunities for location information in communications for location-based authorizations being hacked and/or by enabling local location monitoring to be used in combination with remote location monitoring).

As indicated above, FIGS. 1A-1C are provided as an example. Other examples may differ from what is described with regard to FIGS. 1A-1C. The number and arrangement of devices shown in FIGS. 1A-1C are provided as an example. In practice, there may be additional devices, fewer devices, different devices, or differently arranged devices than those shown in FIGS. 1A-1C. Furthermore, two or more devices shown in FIGS. 1A-1C may be implemented within a single device, or a single device shown in FIGS. 1A-1C may be implemented as multiple, distributed devices. Additionally, or alternatively, a set of devices (e.g., one or more devices) shown in FIGS. 1A-1C may perform one or more functions described as being performed by another set of devices shown in FIGS. 1A-1C.

FIG. 2 is a diagram of an example environment 200 in which systems, devices, and/or methods described herein may be implemented. As shown in FIG. 2, environment 200 may include a multi-function transaction card 210, a transaction terminal 220, a user device 230, a network 240, a transaction backend 250, one or more wireless access points 260, and a card management system 270. Devices of environment 200 may interconnect via wired connections, wireless connections, or a combination of wired and wireless connections.

Multi-function transaction card 210 includes a transaction card capable of storing and/or communicating data for a PoS transaction with transaction terminal 220. For example, multi-function transaction card 210 may store or communicate data including account information (e.g., an account identifier, a cardholder identifier, etc.), expiration information of multi-function transaction card 210, banking information, transaction information (e.g., a payment token), or the like. For example, to store or communicate the data, multi-function transaction card 210 may include a magnetic stripe component and/or an IC chip (e.g., an EMV chip).

In some implementations, multi-function transaction card 210 may include a card body in or on which various components are embedded. In some implementations, multi-function transaction card 210 may include an antenna to communicate data associated with transaction terminal 220 and/or may be capable of communicating wirelessly (e.g., via Bluetooth, BLE, or NFC) with another device, such as transaction terminal 220, a digital wallet, or the like. In some implementations, multi-function transaction card 210 may communicate with transaction terminal 220 to complete a transaction (e.g., based on being moved within communicative proximity of transaction terminal 220). Additional details regarding components of multi-function transaction card 210 are described below.

Transaction terminal 220 includes one or more devices to facilitate processing a transaction via multi-function transaction card 210. Transaction terminal 220 may include a PoS terminal, a security access terminal, an ATM terminal, or the like. Transaction terminal 220 may include one or more input devices and/or output devices to facilitate obtaining transaction card data from multi-function transaction card 210 and/or interaction or authorization from a cardholder of multi-function transaction card 210. Example input devices of transaction terminal 220 may include a number keypad, a touchscreen, a magnetic stripe reader, a chip reader, and/or an RF signal reader. Example output devices of transaction terminal 220 may include a display device, a speaker, and/or a printer.

User device 230 includes one or more devices capable of receiving, generating, storing, processing, and/or providing information associated with multi-function transaction card 210. For example, user device 230 may include a communication device and/or a computing device, such as a mobile phone (e.g., a smart phone, a radiotelephone, etc.), a desktop computer, a laptop computer, a tablet computer, a handheld computer, a gaming device, a wearable communication device (e.g., a smart wristwatch, a pair of smart eyeglasses, etc.), or a similar type of device. In some implementations, user device 230 may include application logic capable of facilitating communications between transaction terminal 220 and multi-function transaction card 210.

Network 240 includes one or more wired and/or wireless networks. For example, network 240 may include a wireless wide area network (WWAN), a cellular communication network (e.g., a long-term evolution (LTE) network, a code division multiple access (CDMA) network, a 3G network, a 4G network, a 5G network, another type of next generation network, etc.), a public land mobile network (PLMN), a local area network (LAN), a wireless local area network (WLAN) (e.g., a Wi-Fi network), a wide area network (WAN), a metropolitan area network (MAN), a personal area network (e.g., a Bluetooth network), an NFC network, a telephone network (e.g., the Public Switched Telephone Network (PSTN)), a private network, an ad hoc network, an intranet, the Internet, a fiber optic-based network, a cloud computing network, and/or a combination of these or other types of networks.

Transaction backend 250 includes one or more devices associated with a bank and/or a transaction card association that authorizes transactions and/or facilitates a transfer of funds or payments between an account of a cardholder of multi-function transaction card 210 and an account of an individual or business of transaction terminal 220. For example, transaction backend 250 may include one or more devices of one or more issuing banks associated with a cardholder of multi-function transaction card 210, one or more devices of one or more acquiring banks (or merchant banks) associated with transaction terminal 220, and/or one or more devices associated with one or more card associations (e.g., VISA® or MASTERCARD) associated with multi-function transaction card 210. Accordingly, in response to receiving transaction card data associated with multi-function transaction card 210 from transaction terminal 220, various devices of banking institutions and/or card associations of transaction backend 250 may communicate to authorize the transaction and/or transfer funds between the accounts associated with multi-function transaction card 210 and/or transaction terminal 220.

Wireless access point 260 includes one or more devices capable of communicating with multi-function transaction card 210, transaction terminal 220, and/or user device 230. In some implementations, wireless access point 260 may include an access point of the network 240. More specifically, wireless access point 260 may include a wireless router (e.g., a Wi-Fi router), a base station (e.g., a radio base station, a node B, an evolved node B (eNB), a gNB, a cellular site, a cellular tower, a transmit receive point (TRP), a radio access node, or the like), or a similar type of device. As described elsewhere herein, wireless access point 260 may be configured to transmit broadcast messages with an identifier of wireless access point 260 to permit multi-function transaction card 210 to determine whether the multi-function transaction card is in an authorized area.

Card management system 270 includes one or more devices capable of receiving, generating, storing, processing, providing, and/or routing information associated with configuring location-based control of a function of the multi-function transaction card 210, as described elsewhere herein. Card management system 270 may include a communication device and/or a computing device. For example, card management system 270 may include a server, such as an application server, a client server, a web server, a database server, a host server, a proxy server, a virtual server (e.g., executing on computing hardware), or a server in a cloud computing system. In some implementations, card management system 270 includes computing hardware used in a cloud computing environment.

As further shown in FIG. 2, multi-function transaction card 210 may include a power bus 272, a bus 274, a radio frequency (RF)/near field communication (NFC) component 276 (shown as and referred to herein as “RF/NFC 276”), a secure element 278, an NFC antenna 280, an NFC front end 282, a power source 284, a controller 286, a power management component 288, an input device 290, an output device 292, and/or a communication device 294.

Power bus 272 includes a component that permits the delivery of power to various components of multi-function transaction card 210. Bus 274 includes a component that permits communication among various components of multi-function transaction card 210. RF/NFC 276 may include a communication link that permits data delivery between secure element 278, NFC antenna 280, and NFC front end 282.

Power source 284 includes one or more devices, internal to multi-function transaction card 210, capable of supplying power. For example, power source 284 may include a battery (e.g., a rechargeable battery or a non-rechargeable battery), a power supply, and/or a capacitor (e.g., a supercapacitor or an ultracapacitor). In some implementations, a component of multi-function transaction card 210 (e.g., controller 286, secure element 278, and/or NFC front end 282) may obtain power from power source 284 when multi-function transaction card 210 is to perform a transaction. In some aspects, multi-function transaction card 210 may include a single power source 284, which may supply power for performing a transaction and/or may supply power to one or more other components of multi-function transaction card 210 (e.g., a processor, a storage component, an input component, an output component, and/or a communication interface). In some aspects, multi-function transaction card 210 may include multiple power sources 284. In some aspects, a single power source 284 may be dedicated to supplying power solely for performing a transaction, while other power sources 284 may supply power to other components of multi-function transaction card 210. In some implementations, multi-function transaction card 210 may include one or more solar cells and associated circuitry that enable various components of multi-function transaction card 210 to be powered by solar energy.

Power management component 288 includes one or more devices capable of controlling the delivery of power to various components of multi-function transaction card 210 and/or controlling charging of power source 284. For example, power management component 288 may include a switch, a gate, a controller, a regulator, a processing component, a bidirectional logic level shifter, and/or a diode. In some implementations, power management component 288 may control signals between controller 286 and secure element 278 (e.g., to couple or decouple controller 286 and secure element 278, and/or to prevent signals from being passed between controller 286 and secure element 278) (e.g., based on a determined location of the multi-function transaction card 210, as described herein).

Controller 286 includes one or more devices capable of receiving, generating, storing, processing, and/or providing information and/or instructions that assist with controlling a function of the multi-function transaction card 210. For example, controller 286 may include a processor and/or a memory, as described elsewhere herein. In some implementations, controller 286 may be directly, communicatively coupled to secure element 278 (e.g., via a dedicated, single-wire communication link).

Secure element 278 includes one or more devices capable of securely hosting an operating system and/or an application, and/or storing confidential information (e.g., a credential or cryptographic information). For example, secure element 278 may include a universal integrated circuit card (UICC), a secure digital (SD) card (e.g., a microSD card), and/or an embedded secure element. In some implementations, secure element 278 may include a tamper resistant hardware platform. In some implementations, secure element 278 may include one or more processors (e.g., one or more microcontrollers) certified by a standard body group, such as an EMV Consortium (EMVCo) certified (e.g., 16-bit) secure microcontroller. In some implementations, secure element 278 may host a personalized card application and a cryptographic key required to perform a financial transaction (e.g., with transaction terminal 220). In some implementations, secure element 278 may store a credential associated with multi-function transaction card 210 and/or another transaction card, such as a username, a password, biometric information, a token, and/or a certificate for signing documents.

In some implementations, secure element 278 may include application logic configured to communicate with NFC front end 282, such as to cause NFC front end 282 to provide card data from secure element 278 to transaction terminal 220 to submit a payment. In some implementations, secure element 278 may include application logic configured to communicate with controller 286, such as to cause controller 286 to communicate with a user device (e.g., user device 230) to facilitate online data authentication relating to a transaction, and/or to receive instructions from controller 286 to initiate transaction processing. In some implementations, secure element 278 may include application logic configured to receive inputs from input device 290 (e.g., directly or via controller 286) and/or to provide outputs to output device 292 (e.g., directly or via controller 286).

NFC antenna 280 includes an antenna capable of transmitting and/or receiving information using an NFC protocol. For example, NFC antenna 280 may include a loop antenna (e.g., an NFC loop antenna) and/or an inductor (e.g., an NFC inductor). In some implementations, NFC antenna 280 may be integrated into, or with, secure element 278 and/or NFC front end 282 (e.g., may be part of the same integrated circuit, such as a transaction IC).

NFC front end 282 includes one or more devices capable of communicating with external devices, such as multi-function transaction card 210 and/or transaction terminal 220, using an NFC protocol. NFC front end 282 may include one or more radio modules for receiving and/or emitting NFC signals. NFC front end 282 may include one or more processors (e.g., microprocessor(s) and/or microcontroller(s)) and/or be coupled to one or more processors, such as controller 286 and/or processor(s) included in secure element 278.

Although not shown, in some implementations, multi-function transaction card 210 may include a transaction IC that includes an integrated circuit connecting secure element 278, NFC antenna 280, and/or one or more other components of multi-function transaction card 210. For example, the transaction IC may include secure element 278, NFC antenna 280, NFC front end 282, connection(s) between secure element 278, NFC antenna 280, and/or NFC front end 282.

Input device 290 includes one or more components that permit multi-function transaction card 210 to receive information, such as via user input (e.g., to initiate a transaction, such as to receive card data from multi-function transaction card 210). For example, input device 290 may include an input component described elsewhere herein. Output device 292 includes one or more components that permit multi-function transaction card 210 to provide output information (e.g., relating to transaction processing associated with multi-function transaction card 210 and/or transaction terminal 220). For example, output device 292 may include an output component described elsewhere herein. Communication device 294 includes a transceiver-like component that enables multi-function transaction card 210 to communicate with other devices. For example, communication device 294 may include a communication component described elsewhere herein.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300, which may correspond to multi-function transaction card 210, transaction terminal 220, user device 230, transaction backend 250, wireless access point 260, and/or card management system 270. In some implementations, multi-function transaction card 210, transaction terminal 220, user device 230, transaction backend 250, wireless access point 260, and/or card management system 270 may include one or more devices 300 and/or one or more components of device 300. As shown in FIG. 3, device 300 may include a bus 310, a processor 320, a memory 330, a storage component 340, an input component 350, an output component 360, and a communication component 370.

Bus 310 includes a component that enables wired and/or wireless communication among the components of device 300. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform a function. Memory 330 includes a random access memory, a read only memory, and/or another type of memory (e.g., a flash memory, a magnetic memory, and/or an optical memory).

Storage component 340 stores information and/or software related to the operation of device 300. For example, storage component 340 may include a hard disk drive, a magnetic disk drive, an optical disk drive, a solid state disk drive, a compact disc, a digital versatile disc, and/or another type of non-transitory computer-readable medium. Input component 350 enables device 300 to receive input, such as user input and/or sensed inputs. For example, input component 350 may include a touch screen, a keyboard, a keypad, a mouse, a button, a microphone, a switch, a sensor, a global positioning system component, an accelerometer, a gyroscope, and/or an actuator. Output component 360 enables device 300 to provide output, such as via a display, a speaker, and/or one or more light-emitting diodes. Communication component 370 enables device 300 to communicate with other devices, such as via a wired connection and/or a wireless connection. For example, communication component 370 may include a receiver, a transmitter, a transceiver, a modem, a network interface card, and/or an antenna.

Device 300 may perform one or more processes described herein. For example, a non-transitory computer-readable medium (e.g., memory 330 and/or storage component 340) may store a set of instructions (e.g., one or more instructions, code, software code, and/or program code) for execution by processor 320. Processor 320 may execute the set of instructions to perform one or more processes described herein. In some implementations, execution of the set of instructions, by one or more processors 320, causes the one or more processors 320 and/or the device 300 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

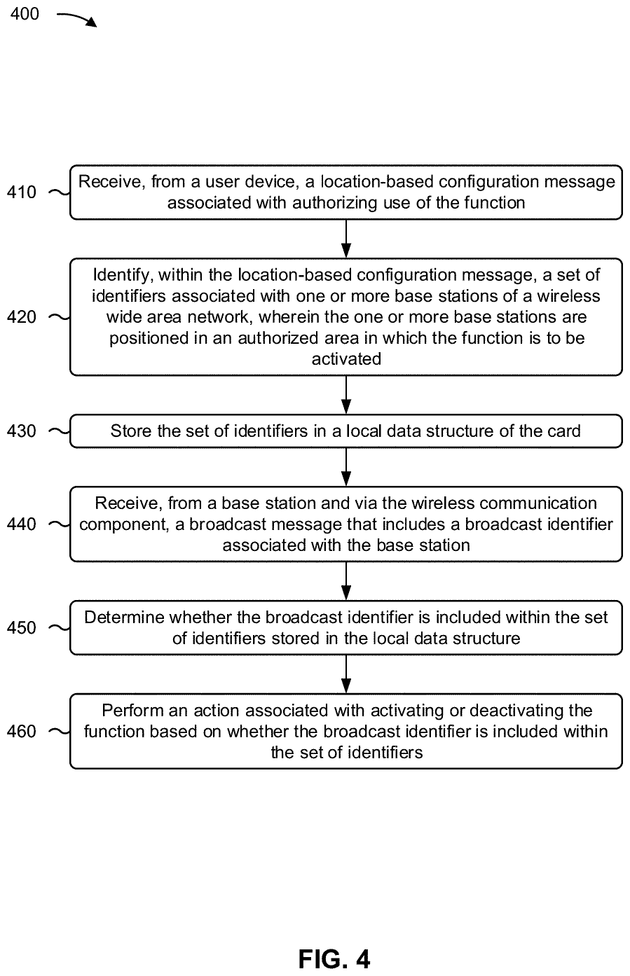

FIG. 4 is a flowchart of an example process 400 associated with location-based control of a function. In some implementations, one or more process blocks of FIG. 4 may be performed by a card (e.g., multi-function transaction card 210). In some implementations, one or more process blocks of FIG. 4 may be performed by another device or a group of devices separate from or including the card, such as a user device (e.g., user device 230) and/or a card management system (e.g., card management system 270). Additionally, or alternatively, one or more process blocks of FIG. 4 may be performed by one or more components of device 300, such as processor 320, memory 330, storage component 340, input component 350, output component 360, and/or communication component 370.

As shown in FIG. 4, process 400 may include receiving, from a user device, a location-based configuration message associated with authorizing use of the function (block 410). As further shown in FIG. 4, process 400 may include identifying, within the location-based configuration message, a set of identifiers associated with one or more base stations of a wireless wide area network, wherein the one or more base stations are positioned in an authorized area in which the function is to be activated (block 420). As further shown in FIG. 4, process 400 may include storing the set of identifiers in a local data structure of the card (block 430). As further shown in FIG. 4, process 400 may include receiving, from a base station and via the wireless communication component, a broadcast message that includes a broadcast identifier associated with the base station (block 440). As further shown in FIG. 4, process 400 may include determining whether the broadcast identifier is included within the set of identifiers stored in the local data structure (block 450). As further shown in FIG. 4, process 400 may include performing an action associated with activating or deactivating the function based on whether the broadcast identifier is included within the set of identifiers (block 460).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A card configured for local location-based control of a function, the card comprising:
a wireless communication component;
one or more memories; and
one or more processors, communicatively coupled to the one or more memories, configured to:
receive, from a user device, a location-based configuration message associated with authorizing use of the function;
identify, within the location-based configuration message, a set of identifiers associated with one or more base stations of a wireless wide area network,
wherein the one or more base stations are positioned in an authorized area in which the function is to be activated;
store the set of identifiers in a local data structure of the card;
receive, from a base station and via the wireless communication component, a broadcast message that includes a broadcast identifier associated with the base station;
determine whether the broadcast identifier is included within the set of identifiers stored in the local data structure; and
perform an action associated with activating or deactivating the function based on whether the broadcast identifier is included within the set of identifiers.

2. The card of claim 1, wherein the one or more processors are further configured to:
prior to receiving the location-based configuration message, establish a communication link with the user device based on the user device being authorized to configure the function,
wherein the location-based configuration message is received via the communication link.

3. The card of claim 1, wherein the one or more processors, when performing the action, are configured to:
activate at least one of a chip of the card, a magnetic stripe component of the card, or a near-field communication component of the card based on determining that the broadcast identifier is included within the set of identifiers in the local data structure, or
deactivate at least one of the chip, the magnetic stripe component, or the near-field communication component based on determining that the broadcast identifier is not included within the set of identifiers in the local data structure.

4. The card of claim 1, wherein the one or more processors, when performing the action, are configured to:
cause the card to transmit account information, associated with facilitating a transaction, to a transaction terminal based on a determination that the broadcast identifier is included within the set of identifiers, or
cause the card to refrain from transmitting the account information to the transaction terminal based on a determination that the broadcast identifier is not included within the set of identifiers.

5. The card of claim 1, wherein the function includes an operation associated with facilitating a transaction involving an account associated with the card.

6. The card of claim 1, wherein the one or more processors, when performing the action, are configured to:
determine that the broadcast identifier is included within the set of identifiers in the local data structure; and
activate one or more components of the card that are associated with the function based on determining that the broadcast identifier is included within the set of identifiers in the local data structure.

7. The card of claim 1, wherein the one or more processors, when performing the action, are configured to:
determine that the broadcast identifier is not included within the set of identifiers in the local data structure; and
deactivate one or more components of the card that are associated with the function based on determining that the broadcast identifier is not included within the set of identifiers in the local data structure.

8. A method of locally controlling a function of a card, comprising:
receiving, by the card, a set of identifiers that identify a set of wireless access points;
monitoring, via a wireless communication component of the card, for broadcast messages to determine whether the card is within an area associated with one or more wireless access points of the set of wireless access points;
determining, by the card, that a received broadcast message includes an identifier of the set of identifiers; and
activating, by the card and based on the received broadcast message including the identifier, the function of the card.

9. The method of claim 8, wherein the set of identifiers is received within a location-based configuration message from a user device that is associated with an account of the card.

10. The method of claim 8, wherein the set of wireless access points comprises a set of base stations of a cellular communication network.

11. The method of claim 8, wherein monitoring for the broadcast messages comprises monitoring for the broadcast messages using a wireless communication protocol that is associated with at least one of:
a local area network;
a wide area network; or
a cellular communication network.

12. The method of claim 8, wherein the function includes at least one of:
an operation associated with facilitating a transaction involving an account associated with the card; or
an operation associated with updating the set of identifiers.

13. The method of claim 8, wherein activating the function comprises at least one of:
activating a component of the card that performs an operation of the function.

14. The method of claim 8, wherein the received broadcast message is a first received broadcast message and the identifier is a first identifier of the set of identifiers, and the method further comprising:
determining that a second received broadcast message includes a second identifier that is not included within the set of identifiers; and
deactivating, based on the second identifier not being included within the set of identifiers, the function of the card.

15. A non-transitory computer-readable medium storing a set of instructions, the set of instructions comprising:
one or more instructions that, when executed by one or more processors of a card, cause the card to:
receive, from a wireless access point and via a wireless communication component of the card, a message that includes an identifier of the wireless access point;
determine, based on the identifier, that the card is within a geographic area in which use of a function of the card is authorized; and
activate the function based on determining that the card is within the geographic area.

16. The non-transitory computer-readable medium of claim 15, wherein the one or more instructions, that cause the card to determine that the card is within the geographic area, cause the card to:
determine that the identifier matches one of a set of identifiers stored in a local data structure of the card; and
determine that the card is within the geographic area based on the identifier matching the one of the set of identifiers.

17. The non-transitory computer-readable medium of claim 15, wherein the set of identifiers comprises one of:
a preconfigured set of read-only identifiers that is fixed within the local data structure; or
a reconfigurable set of identifiers that is adjustable within the local data structure.

18. The non-transitory computer-readable medium of claim 15, wherein the wireless access point comprises a base station of a wireless communication network and the geographic area comprises a cell, of the wireless communication network, that is associated with the base station.

19. The non-transitory computer-readable medium of claim 15, wherein the function includes an operation associated with facilitating a transaction involving an account associated with the card.

20. The non-transitory computer-readable medium of claim 15, wherein the message is a first message, the wireless access point is a first wireless access point, and the geographic area is a first geographic area,
wherein the one or more instructions, when executed by the one or more processors, further cause the card to:
receive, via the wireless communication component, a second message associated with a second wireless access point;
determine, based on the second message, that the card is within a second geographic area in which use of the function of the card is not authorized; and
deactivate the function based on determining that the card is within the second geographic area.
